(19) United States
(12) Patent Application Publication
(10) Pub. No.: US 2009/0051200 A1
(43) Pub. Date: Feb. 26, 2009

(54) Regulating Device for a Lateral Part of a Seat and Method for Producing a Lateral Part

(75) Inventors: Veit Stoessel, Nurnberg (DE); Walter Schindlegger, Seitenstetten (AT)

Correspondence Address: KANG INTELLECTUAL PROPERTY LAW, LLC, 214 ELM STREET, SUITE 106, WASHINGTON, MO, 63090, US

(73) Assignee: SCHUKRA GERATEBAU AG, Berndorf (AT)

(21) Appl. No.: 11/910,688

(22) PCT Filed: Mar. 31, 2006
(86) PCT No.: PCT/EP2006/002982

§ 371 Date: Apr. 18, 2008

(30) Foreign Application Priority Data
Apr. 8, 2005 (DE) 10 2005 016 474.9

(51) Int. Cl. A47C 7/14; B60N 2/02

(52) U.S. Cl. 297/284.9; 296/68.1

(57) ABSTRACT

For the height adjustment of a side cheek (6) of a seat (5), a pulling force is exerted with the aid of a corresponding adjusting mechanism (4) on a movable component (7, 8) of the side cheek (6) in order to variably adjust the height of the side cheek (6). For this purpose, in particular an adjusting element (11) which is mounted displaceably on a link (9) is preferably displaced along a guide opening (10) provided in the link (9) in order to describe a predefined curve along which the side cheek is lowered or raised.

The present invention relates to an adjusting device for the height adjustment of a side cheek of a seat, in particular a motor vehicle seat, and to a method for adjusting a side cheek of a seat.

Side cheeks can be arranged for example in a longitudinal direction on both sides of a seat area or a backrest of a seat and serve in particular to provide a person sitting on the seat, for example a driver of a motor vehicle, with better lateral support, in particular when travelling round a bend. Side cheeks of this type are very common particularly in so-called sports seats.

In order to provide a person sitting on the seat with adequate support, the side cheeks must be of a certain height. In a motor vehicle, this may lead to the side cheeks obstructing the person when getting into and out of the vehicle.

In order to overcome this problem, it is known for example from DE 199 50 702 A1 to alter the volume of the side cheeks by means of inflatable balloons arranged under the cover. However, this solution means a relatively high technical outlay particularly if the adjustment of the side cheek is to take place automatically, for example coupled to the opening of a door. Further problems which may arise with a pneumatic height adjustment of a side cheek are the noises associated with the inflation of the balloon, a possible loss of pressure in the balloon and a possibly non-optimal adaptation of the cover to the balloon, which may lead to creases in the cover.

The object of the present invention is therefore to provide an improved adjusting device for a side cheek. In particular, it is an object to provide an adjusting device for a side cheek which is simple to realise and can be controlled in a simple manner.

This object is achieved according to the invention by an adjusting device according to Claim 1 and a method according to Claim 17. The dependent claims define preferred or advantageous exemplary embodiments of the invention.

An adjusting device according to the invention for the height adjustment of a side cheek of a seat comprises an adjusting mechanism which is to be coupled to a movable component of the side cheek and is configured in such a way that, on actuation of the adjusting mechanism, a pulling force is exerted on the movable component of the side cheek by the adjusting mechanism in order to alter a height of the side cheek relative to a surface of the seat. The adjusting device thus enables, by exerting a pulling force on the component of the side cheek coupled to it, the side cheek to be pulled towards the respective seat surface or backrest surface in order to thereby reduce the height of the side cheek by which the latter protrudes from the seat surface or backrest surface.

The adjusting mechanism preferably comprises an adjusting element which in use is to be coupled to the movable component of the side cheek, and guide means which define a path along which the adjusting element can be moved on the guide means. To define the path along which the adjusting element can be moved, the guide means can comprise a guide opening which is provided on a guide link or a guide projection which is provided on a guide link and with which a guide projection provided on the adjusting element or a guide opening provided on the adjusting element engages respectively, so that the adjusting element is mounted displaceably on the guide link, its path being defined by the shape of the guide opening. This configuration makes it possible to adjust the side cheek of the seat according to a curve which may also have a more complicated shape.

In a preferred exemplary embodiment, at least one section of the guide opening is curved, while another section is substantially straight. This configuration of the guide opening enables the adjustment of the side cheek according to a curve which, starting from an extended position of the side cheek, runs first outwards with respect to a seat area and then substantially perpendicular to the surface of the seat, so that the side cheek is first pivoted laterally and then moved perpendicular to the seat surface.

The adjusting element can be moved along the guide means with the aid of various actuating devices, for example by a toothed rack coupled to a pinion. In a preferred exemplary embodiment, the adjusting mechanism comprises a Bowden control arrangement in order, by actuation of the Bowden control arrangement, to pull the movable component of the side cheek towards a seat area or away from the seat area in order to alter the height of the side cheek. In particular, a cable of the Bowden control arrangement can be guided via the guide link and coupled to the adjusting element. By using a Bowden control arrangement, it is possible to accommodate an actuating device, for example an electric motor, at a suitable location on or in the seat, even if this location is spatially remote from the position of the adjusting mechanism.

When using a Bowden control arrangement, the adjusting mechanism can be configured in such a way that the side cheek can be both pulled downwards and moved upwards with the aid of the Bowden control, in order thus to variably adjust the height of the side cheek by actuation of a Bowden control or a plurality of Bowden controls.

Alternatively, it is possible for the cable control or Bowden control to act only in one direction, in which case, on actuation of the cable control or Bowden control, energy is absorbed by a mechanical energy storage means, preferably a compression spring, the energy storage means then bringing about or at least assisting, with release of the absorbed mechanical energy, the return movement of the side cheek in the opposite direction.

A seat according to the invention comprises a side cheek having a movable component, and an adjusting device according to an exemplary embodiment of the present invention which is coupled to the movable component. If the side cheek is provided on a seat area of the seat, the movable component is preferably mounted in articulated manner at its rear end. If the side cheek is arranged on a backrest of the seat, the movable component is preferably mounted in articulated manner at its lower end. The articulated mounting of the movable component enables the movable component and thus the side cheek to be adjusted according to a curve defined by the adjusting device.

A seat according to the invention preferably comprises two side cheeks which are arranged for example symmetrically on a seat area or on a backrest of the seat, and which each comprise a movable component which is respectively coupled to an adjusting device according to an exemplary embodiment of the present invention. For each of the adjusting devices, a separate actuating device, for example an electric motor, which is coupled to the Bowden control can be provided. In a preferred exemplary embodiment, the adjusting mechanisms of the adjusting devices are coupled to one another by a closed-circuit Bowden control system, so that they can be actuated by a single electric motor.

The side cheeks can be arranged on a seat area or on a backrest of the seat.

In a method according to the invention for the height adjustment of the side cheek of a seat, an adjusting mechanism coupled to a movable component of the side cheek exerts a pulling force on the movable component of the side cheek in order to alter a height of the side cheek by which the side cheek protrudes from a surface of the seat. The side cheek is preferably adjusted along a curve which, on a reduction of the height of the side cheek, comprises a curved section running outwards with respect to a surface of the seat and a further section oriented substantially perpendicular to the surface of the seat.

The adjusting device according to the invention enables also an automated height adjustment of the side cheeks of a seat, in particular a motor vehicle seat, by simple means, it being possible for the height adjustment to be coupled for example to the actuation of the ignition of the particular motor vehicle, to the fastening of a safety belt and/or the opening of a door of the motor vehicle or other user actions, in order to adjust the height of the side cheeks automatically in such cases.

The present invention will be explained below in more detail with the aid of a preferred exemplary embodiment with reference to the appended drawing.

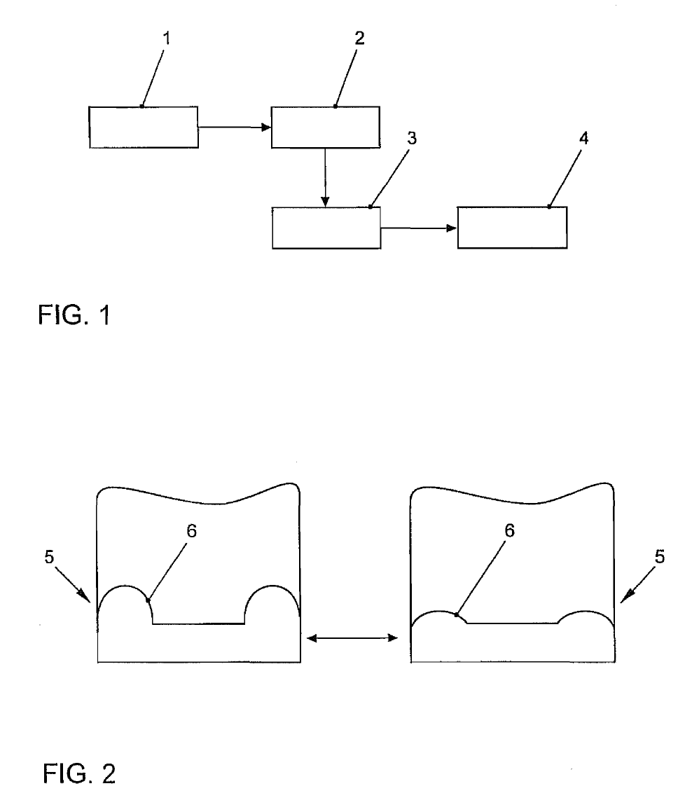

FIG. 1 shows schematically a system for the height adjustment of side cheeks of a seat having an adjusting device according to the invention.

FIG. 2 is an illustration which serves to explain the height adjustment of side cheeks of a seat.

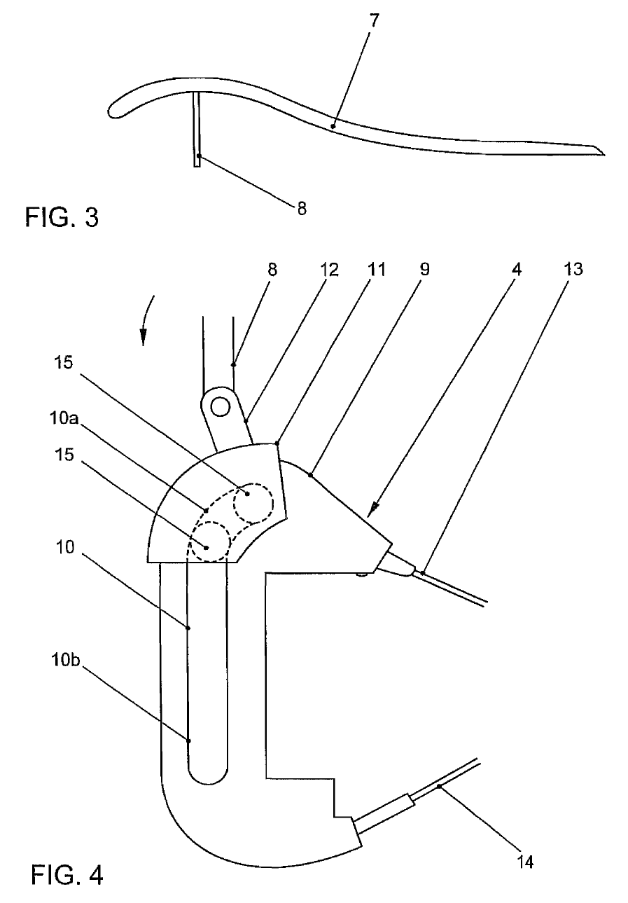

FIG. 3 shows by way of example an illustration of a movable component of a side cheek which can be adjusted with the aid of an adjusting device according to the invention.

FIG. 4 shows an adjusting mechanism of an adjusting device according to a preferred exemplary embodiment of the present invention in a first operating position.

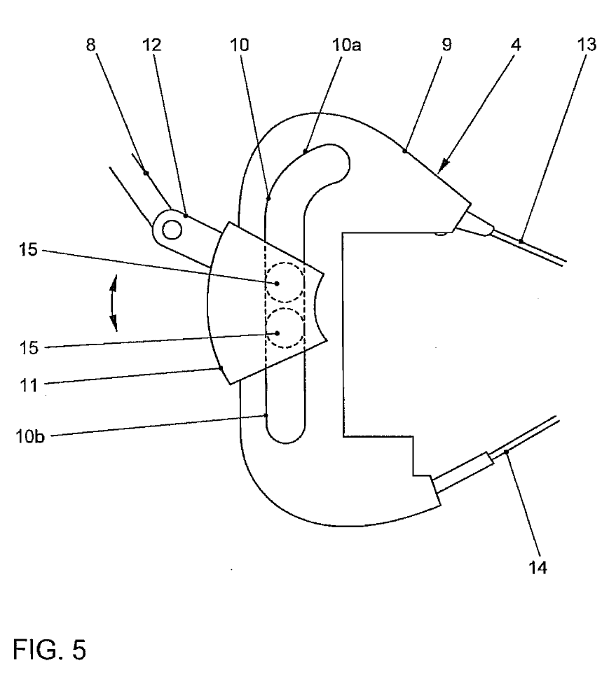

FIG. 5 shows the adjusting mechanism of FIG. 4 in a second operating position.

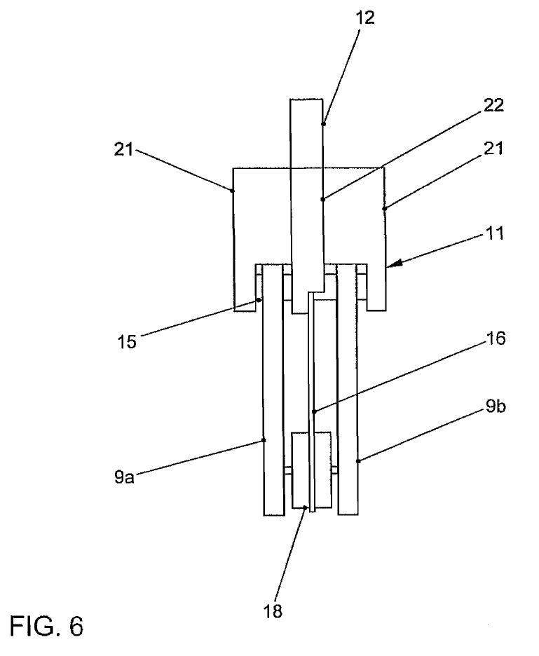

FIG. 6 is a side view of the adjusting mechanism of FIG. 4.

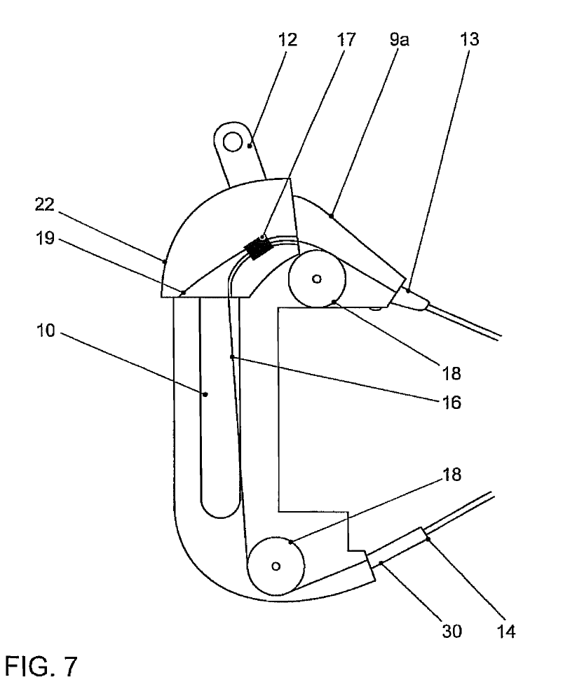

FIG. 7 is a broken-open partial view of the adjusting mechanism of FIG. 4.

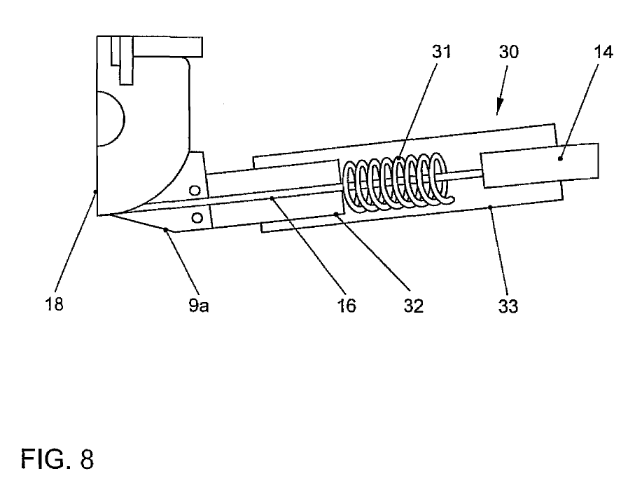

FIG. 8 shows schematically a spring arrangement which can be employed in the adjusting device according to the invention.

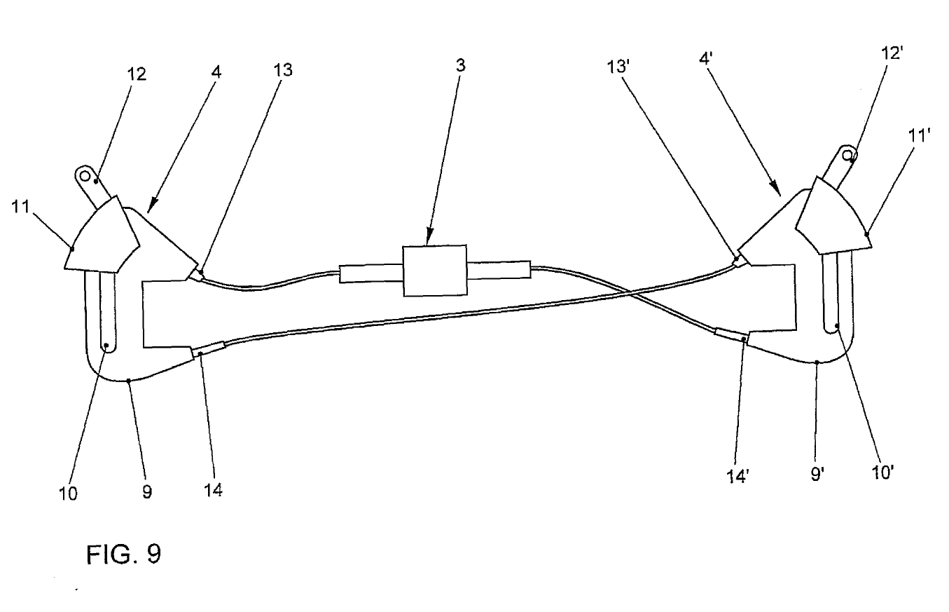

FIG. 9 shows two adjusting mechanisms according to FIG. 4 which are coupled by a closed-circuit Bowden control system.

Illustrated in FIG. 1 in a schematic block diagram is a system for the height adjustment of side cheeks of a seat, in particular a motor vehicle seat, the actuation of the ignition of the motor vehicle, the fastening of a safety belt by a vehicle occupant and/or the opening of a door of the motor vehicle being monitored with the aid of a sensor 1, for example a Hall sensor. A control unit 2 monitors the output signal generated by the sensor 1 and, in dependence on the output signal, controls a drive motor 3 which in turn drives an adjusting mechanism 4 in order to adjust a height of a side cheek of the seat.

As illustrated schematically in FIG. 2, the adjusting mechanism here can be controlled in such a way that, when the ignition of the motor vehicle is switched off, the side cheeks 6 of the seat 5 are adjusted from a relatively high height to a relatively low height, in order to make it easier for the person sitting on the seat to get out. Conversely, the adjusting mechanism can be controlled in such a way that, if a corresponding output signal of the sensor 1 signals that the ignition of the motor vehicle is switched on and/or a seat belt associated with the seat has been fastened, the side cheek is adjusted from a relatively low height to a relatively high height, in order to provide the person sitting on the seat with the greatest possible lateral support.

Preferably, a component 7 coupled to the foam of the respective side cheek 6 is provided in each side cheek 6 of the seat, as illustrated by way of example in FIG. 3. The component 7 runs in FIG. 2 in the longitudinal direction in the respective side cheek 6 and is movably attached to the seat 5 by an end of the component 7 being mounted in articulated manner on a seat frame or backrest frame of the seat. The movable component 7 can be connected to the foam of the side cheek 6 in any desired manner. For example, a reinforcing element can be formed integrally with the foam, which reinforcing element is firmly connected to the component 7. As can be seen from FIG. 3, a bar 8 projects downwards from the component 7, which bar is coupled to the adjusting mechanism 4 indicated schematically in FIG. 1 and explained in more detail below.

FIG. 4 shows an exemplary embodiment of an adjusting mechanism 4 of an adjusting device according to the invention. The adjusting mechanism 4 comprises a link 9, in which there is provided a slot-shaped guide opening 10 which comprises a curved upper section 10a and a substantially straight section 10b. The adjusting mechanism 4 further comprises an adjusting element 11 which is displaceably mounted on the guide link 9. For this purpose, the adjusting element 11 has guide projections 15 which pass through the guide opening 10 of the link 9, so that the adjusting element 11 is displaceable along a curve which is defined substantially by the shape of the guide opening 10. In the exemplary embodiment illustrated in FIG. 4, the adjusting element 11 has two guide projections 15 which have a substantially cylindrical outer circumference, the diameter of which corresponds substantially to the width of the guide opening 10. Projecting from the adjusting element 11 is a projection 12, to which, in an installed state of the adjusting device in the vehicle seat, the downwardly projecting bar 8 of the movable component 7 of the side cheek 6 is coupled.

The adjusting mechanism 4 further comprises a Bowden control 13, 14, the wire cable of the Bowden control being guided via the link 9. The wire cable of the Bowden control is also anchored to the adjusting element 11, so that the adjusting element 11 can be displaced on the link 9 via the wire cable of the Bowden control 13, 14.

If a force acting on the adjusting element is exerted downwards by the wire cable of the Bowden control 13, 14, the adjusting element 11 moves downwards, starting from its uppermost position illustrated in FIG. 4, along the link 9 and reaches an operating position illustrated by way of example in FIG. 5. When the adjusting element 11 moves downwards along the link 9, the projection 12 which is firmly connected to the adjusting element 11 or formed integrally therewith also performs a movement along a curve which comprises a curved upper section and an adjoining substantially straight section. The movement of the projection 12 is transmitted to the movable component 7 of the side cheek 6 via the bar 8. The movable component 7 coupled to the foam of the side cheek 6 transmits the movement in turn to the side cheek 6. The bar 8 of the movable component 7 is preferably rigidly coupled, for example by means of a screw connection, to the projection 12 of the adjusting element 11, so that the curve described by the movable component 7 is determined substantially by the dimensioning of the bar 8, the adjusting element 11 and the guide opening 10. Alternatively, the bar 8 can however also be attached in articulated manner to the projection 12 of the adjusting element 11, in which case the path curve described by the movable component is determined additionally by the elastic properties of the movable component 7.

The link 9 and the adjusting element 11 can have various configurations. In one exemplary embodiment, the link 9 is a single, suitably shaped plate, while the adjusting element 11 has the shape of an inverted U, the legs of which project laterally over the plate of the link 9, a plurality of guide projections 15, which connect the legs, engaging in the guide opening 10 of the link 9. The link 9 and the adjusting element 11 can however also have a more complicated configuration, as explained below.

With reference to FIGS. 6 and 7, which show the adjusting mechanism of the adjusting device according to a preferred exemplary embodiment of the invention in a side view and a broken-open partial view, a preferred configuration of the adjusting mechanism is explained in more detail. In this case, the link 9 comprises first and second link elements 9a and 9b which are plate-shaped, have a substantially identical configuration and have a spaced apart parallel arrangement. Mounted rotatably between the link elements 9a, 9b are deflection rollers 18 for the wire cable 16 of the Bowden control, via which the wire cable 16 is guided. The link elements 9a, 9b are held in the spaced configuration shown in FIG. 6 by a holder (not illustrated in the figures), it being possible for the holder to be formed for example integrally with a fastening for the deflection rollers 18.

As can best be seen in FIG. 6, in this exemplary embodiment the adjusting element 11 comprises a centre element 22, from which the projection 12 protrudes, and two side elements 21. Guide projections in the form of cylindrical guide pins 15 connect each of the side elements 21 to the centre element 22. The side elements can be connected to the centre element 22 in any suitable manner, for example by latching connections or screw connections. In a preferred exemplary embodiment, the guide pins 15 in particular have the dual function to serve simultaneously as leadthroughs for a screw or a bolt, by which screw or bolt the side elements 21 are fastened to the centre element 22. The centre element 22 has, as can best be seen in the broken-open view of FIG. 7, a leadthrough for the wire cable 16 of the Bowden control 13, 14, which cable is anchored to the centre element 22 by a fastening 17. The leadthrough for the wire cable 16 of the Bowden control 13, 14 has a section which is configured in the form of a wedge-shaped cutout 19 and is arranged at the lower end of the adjusting element 11, in order to enable sufficient mobility of the wire cable 16 in the different operating positions of the adjusting element 11.

An adjustment of the adjusting element 11 along the link 9 with the aid of a Bowden control or a plurality of Bowden controls which couple the adjusting element to an actuating device, for example an electric motor, can be realised in various ways. For example, a first and a second cable pulley or cable roller can be provided which are both coupled to the same electric motor and are driven to rotate by the latter, an end of the wire cable 16 associated with the Bowden control section 13 being coupled to the first cable pulley and an end of the wire cable 16 associated with the Bowden control section 14 being coupled to the second cable pulley in such a way that, on rotation of the electric motor in a first direction of rotation, the section of the wire cable 16 associated with the Bowden control section 13 is lengthened and the section of the wire cable 16 associated with the Bowden control section 14 is shortened by the same amount, so that effectively the wire cable is displaced along the Bowden control. On rotation of the electric motor in a second direction of rotation opposite the first direction of rotation, the lower section of the wire cable 16 in FIG. 7 is lengthened, while the upper section of the wire cable 16 is shortened by the same extent. As a result, the wire cable 16 is displaced along the Bowden control and along the guide link 9, whereby the adjusting element 11 is moved along the guide opening 10. In particular, in this exemplary embodiment it is possible for the wire cable 16 of the Bowden control 13, 14 to exert a force which acts on the adjusting element and which can be directed both upwards and downwards.

In alternative exemplary embodiments, the wire cable of the Bowden control can also be coupled to the adjusting element 11 in such a way that it can exert a force on the adjusting element 11 only in one direction, i.e. either upwards or downwards, while elastic energy storage means are provided which, on displacement of the adjusting element along the link, store mechanical energy and provide a restoring force for the adjusting element in the opposite direction. It is thus possible for example for a compression or tension spring to exert an upwardly directed force on the adjusting element 11, while the Bowden control is coupled to the adjusting element 11 in such a way that it can move the element downwards along the link 9. It is also possible for a compression or tension spring coupled to the adjusting element 11 to exert a downwardly directed force on the element, while the Bowden control is coupled to the adjusting element in such a way that it can move the element upwards along the link 9.

As will be explained now with reference to FIG. 8, the elastic energy storage means does not however have to be coupled directly to the adjusting element 11, but can rather also cooperate in a suitable manner with elements of the Bowden control 13, 14 in order to provide a restoring force acting on the adjusting element. Illustrated in FIG. 8 by way of example is an arrangement 30 which can be provided at a lower section of the adjusting mechanism 4. In this case, a helical spring 31 is arranged around the wire cable 16 of the Bowden control and between an extension 32 projecting from the adjusting mechanism and an end portion of a sheath of the Bowden cable 14. The arrangement 30 is surrounded by a sleeve 33. As soon as the end section of the sheath of the Bowden control 14 comes into contact with the spring 31 when the adjusting element 11 in FIG. 7 is moved downwards, the arrangement 30 provides a restoring force which counteracts further displacement of the adjusting element 11 downwards.

FIG. 9 shows schematically a preferred Bowden control arrangement for actuating two adjusting mechanisms 4, 4′ which in use are arranged on a seat in order to adjust a pair of side cheeks. The structure and operation of the further adjusting mechanism 4′ are identical to the structure and operation of the adjusting mechanism 4, so that corresponding components of the further adjusting mechanism 4′ are provided with corresponding reference signs. In the example illustrated in FIG. 9, a section 14, 13′ of the Bowden control leads from a lower section of the adjusting mechanism 4 to an upper section of the adjusting mechanism 4′, while a section 13 of the Bowden control coupled to the upper section of the adjusting mechanism 4 and a section 14′ coupled to the lower section of the further adjusting mechanism 4′ leads to the drive motor 3. In this arrangement, the wire cable of the Bowden control runs through both the adjusting mechanism 4 and the further adjusting mechanism 4′ in the vertical direction with the same orientation, so that on displacement of the wire cable of the Bowden control, the adjusting element 11 of the adjusting mechanism 4 and the adjusting element 11′ of the further adjusting mechanism 4′ are moved upwards or downwards symmetrically by the same distance. The ends of the wire cable associated with the sections 13 and 14′ of the Bowden control can in turn, as already described above, be coupled to a pair of cable pulleys or cable rollers in such a way that they are wound up or unwound by the same length on rotation of the drive motor 3 in phase opposition.

As also illustrated schematically in FIG. 9, the adjusting mechanism 4 and the further adjusting mechanism 4′ are in use arranged in a seat in such a way that the guide openings 10 and 10′ assume a symmetrical arrangement relative to one another with respect to a centre plane of the seat. In particular, the adjusting mechanisms 4, 4′ are arranged in such a way that, on movement of the adjusting elements 11, 11′ downwards, the adjusting elements are simultaneously moved outwards with respect to the seat area. It should however be noted that a large number of other configurations and arrangements of the guide openings 10, 10′ are possible which can define any desired contours along which the side cheeks of the seat can be lowered or lifted.

While in the adjusting device set out in detail above a Bowden control arrangement has been employed for displacing the adjusting element 11 on the guide link 9, alternatively any other suitable actuating device can be used for this purpose. Thus, for example, a toothed rack may be provided which is coupled to a pinion and is coupled to the adjusting element 11, in order to exert a pulling or pushing force on this element and displace it along the guide link 9.

As is evident from the above explanation of a preferred exemplary embodiment, the invention provides an adjusting device for a side cheek of a seat which is simple to realise, which can be automatically controlled in a simple manner and which enables a side cheek of a seat to be lowered or displaced upwards according to a predefined contour. The adjusting device according to the invention can be used in any seats, preferably in motor vehicle seats. In particular, the present invention can be employed in side cheeks arranged on a seat area or a backrest of a motor vehicle seat.

1-18. (canceled)

19. An adjusting device for the height adjustment of a side cheek of a seat, having an adjusting mechanism which is to be coupled to a movable component of the side cheek and which is configured in such a way that, on actuation of the adjusting mechanism, a pulling force is exerted on the movable component of the side cheek by the adjusting mechanism in order to alter a height of the side cheek by which the side cheek protrudes from a surface of the seat,
wherein the adjusting mechanism comprises an adjusting element to be coupled to the movable component of the side cheek and guide means on which the adjusting element is movably arranged and which define a path along which the adjusting element can be moved,
wherein the guide means comprise a guide opening which is provided in a guide link and in which the adjusting element is displaceably mounted, or a guide projection which is provided on a guide link and with which a guide opening provided on the adjusting element engages, and
wherein at least one section of the guide opening has a curved shape.

20. An adjusting device according to claim 19,
wherein at least one section of the guide opening is substantially straight.

21. An adjusting device according to claim 19,
wherein the adjusting mechanism comprises a Bowden control arrangement in order, by actuation of the Bowden control arrangement, to pull the movable component towards a seat area in order to reduce the height of the side cheek, and/or to pull it away from a seat area in order to increase the height of the side cheek.

22. An adjusting device according to claim 21,
wherein a cable of the Bowden control arrangement is guided via the guide link and coupled to the adjusting element.

23. An adjusting device according to claim 19,
wherein the adjusting mechanism is configured in such a way that, when the pulling force is exerted on the movable component of the side cheek in order to reduce the height of the side cheek, simultaneously the movable component is moved outwards relative to a surface of the seat.

24. An adjusting device according to claim 19,
wherein a mechanical energy storage means is provided which, when the pulling force is exerted by the adjusting mechanism, absorbs mechanical energy.

25. An adjusting device according to claim 24,
wherein the mechanical energy storage means is resilient.

26. A seat, comprising
a side cheek having a movable component and an adjusting device which is coupled to the movable component in order to alter the height of the side cheek, the adjusting device comprising an adjusting mechanism coupled to the movable component of the side cheek and configured in such a way that, on actuation of the adjusting mechanism, a pulling force is exerted on the movable component of the side cheek by the adjusting mechanism in order to alter a height of the side cheek by which the side cheek protrudes from a surface of the seat,
wherein the adjusting mechanism comprises an adjusting element to be coupled to the movable component of the side cheek and guide means on which the adjusting element is movably arranged and which define a path along which the adjusting element can be moved,
wherein the guide means comprise a guide opening which is provided in a guide link and in which the adjusting element is displaceably mounted, or a guide projection which is provided on a guide link and with which a guide opening provided on the adjusting element engages, and
wherein at least one section of the guide opening has a curved shape.

27. A seat according to claim 26,
wherein the movable component is mounted in articulated manner at one end.

28. A seat according to claim 26, further comprising
a further side cheek with a further movable component, and
a further adjusting device which is coupled to the further movable component in order to alter the height of the further side cheek.

29. A seat according to claim 28,
wherein the adjusting mechanisms of the adjusting device and of the further adjusting device are coupled to one another by a closed-circuit Bowden control system and can be actuated via the closed-circuit Bowden control system.

30. A seat according to claim 28,
wherein the side cheek and the further side cheek are arranged on a seat area of the seat.

31. A method for adjusting the height of a side cheek of a seat, in which an adjusting mechanism coupled to a movable component of the side cheek exerts a pulling force on the movable component of the side cheek in order to alter a height of the side cheek by which the side cheek protrudes from a surface of the seat.

32. A method according to claim 31,
wherein the side cheek is adjusted along a curve which, on a reduction of the height of the side cheek, comprises a curved section running outwards with respect to a surface of the seat and a further section running substantially perpendicular to the surface of the seat.
